(19) United States
(12) Patent Application Publication
(10) Pub. No.: US 2002/0083003 A1
(43) Pub. Date: Jun. 27, 2002

(54) Method and apparatus for the accurate metering of software application usage and the reporting of such usage to a remote site on a public network

(76) Inventors: David C. Halliday, Sunnyvale, CA (US); Mounir Hahad, San Jose, CA (US); Michael A.S. Potts, Palo Alto, CA (US); David W. Lauderback, Pleasanton, CA (US)

Correspondence Address: OPPENHEIMER WOLFF & DONNELLY, P. O. BOX 10356, PALO ALTO, CA, 94303, US

(21) Appl. No.: 09/965,623

(22) Filed: Sep. 26, 2001

Related U.S. Application Data
(60) Provisional application No. 60/235,479, filed on Sep. 26, 2000.

(51) Int. Cl. G06F 17/60

(52) U.S. Cl. 705/52

(57) ABSTRACT

Methods and apparatus are disclosed which provide a system for accurate time and usage based metering of client application or client application feature usage and the reporting of said usage to a site on a public network. The present invention can be used as an alternative to traditional license granting systems, or be used for any other purpose where tracking and metering of valuable resources or services is useful. While the current invention can provide metering and billing capability to software applications akin to the billing systems deployed by telecommunication companies for line and feature usage, the metering can also emulate traditional licensing models and operate in conjunction with traditional licensing systems.

### RELATED APPLICATIONS

This application claims the benefit of U.S. Provisional Application No. 60/235/479, filed Sep. 26, 2000 and entitled Method and Apparatus for Accurate Metering of Software Application Usage and Reporting Such Usage to a Remote Site on a Public Network, the entire contents of such application being expressly incorporated herein by reference.

### BACKGROUND OF THE INVENTION

1. Field of the Invention

The present invention relates to the field of software licensing, and more specifically, to a system for providing centralized time based charging and/or metering of the use of client applications or application features.

2. Background Information

Traditionally, software embodied in applications purchased at a local retailer has been licensed in the form of a right to use on a perpetual basis or in some restricted form such as a period based or invocation based methods. Several commercial software systems exist that provide license control systems that work locally on a computer, over a local network or even over a public network. These include but are not limited to, Globetrotter Software Inc.'s FLEXlm and FLEXmeter product lines; Rainbow Technologies Sentinel line; Aladdin Software's Privilege or HASP lines and Silvaco International's SFLM products.

Software that is sold under perpetual license is usually shipped with an activation key, or sold with no protection at all. With an activation key, the key is used to unlock or install the software. Once the software is installed on a given host it is permanently available. While the software can be moved to an alternative host reinstallation is required and the user is left to ensure that the legal terms of the license are met by removing the original installation. Some vendors place cursory checks in software to ensure that multiple copies of software are not installed on a network using the same activation key. Other more complex methods of protecting perpetual licenses can also be applied as described in Hasebe et al., U.S. Pat No. 5,935,243 entitled “Licensee Notification System”.

Traditional license management software is designed to add some flexibility to the idea of a software license, and to regulate the use of software packages. Typically, license management software will utilize a license file or hardware key that defines how many copies and/or on what machines and under what conditions a given application can be executed. For example, a license file may state that up to four copies of application X may run on any computer if some given expiration date has not been reached. Further, some license management solutions such as FLEXIm also allow application vendors to divide the functionality of an application into several different feature sets (features) and these features can be licensed separately.

Given a license server available either on the local machine or assessable via a network, and given that the license server contains a set of licenses for a given application or feature, a typical control flow for a traditional license management system is as follows:

1. Application starts.

2. The application contacts the license server. If server can not be located the application will quit.

3. The application requests a license for the feature it is about to use.

4. If the server has a license available for the feature and the application is allowed to claim the license (running on correct machine, as correct user etc.), the license is granted and the server decrements the available pool of license for that feature.

5. When the application is granted a license, the application continues. If a license is not granted, the application has a number of options. if the server has licenses but none are currently available (current pool is zero), the application will normally wait and retry the request. If the server can never issue the requested license then the application will terminate.

6. When an application holding a license is finished, it informs the server and the available pool of licenses for the given feature is incremented.

While the control flow above is not intended to be exhaustive, it is intended to give an overview of how a traditional license management system works. This basic licensing model can farther be extended in a number of ways including, but not limited to: using a hierarchy of servers, potentially over a public network, as described in Coley et al., U.S. Pat. No. 5,790,664 entitled, “Automated System For Management of Licensed Software”; implementation of a system for charging on an invocation by invocation basis as described in Frison et al., U.S. Pat. No. 6,049,786 entitled, “Software Pay Per Use Licensing System”; email enabled licensing systems as described in; Yamamura, U.S. Pat. No. 6,023,766, entitled “Software License Control System and Software License Control Equipment.”

It is also possible to limit software usage to a prescribed usage model by measuring or metering how the software is used to ensure that the software is used in accordance with its license. While metering is not new in the world of computers and has been used as a charging system from the early mainframe era, it is once again gaining popularity due to its flexibility.

Metering can take a number of different forms. These include but are not limited to: systems that monitor a computer or set of computers over a period of time as described in Barritz et al., U.S. Pat. No. 6,029,145 entitled, “Software License Verification Process and Apparatus”; systems designed to limit the number of times the software can be used before a recharge, as described in, Kanno, U.S. Pat. No. 5,943,650, “Operation Management System and Operation Management Method”; systems that allow software to be executed only while connected to a master server via a communication link, as described in Ananda, U.S. Pat. 5,495,411 entitled, “Secure Software Rental System Using Continuous Asynchronous Password Verification”.

As an alternative to providing a licensing scheme which mandates and authenticates clients rights to use a given software application, a retroactive approach is also possible. Other than a cursory check that a charging rate exists for a given application or application features, applications can be freely executed without license checks. The usage of the application is monitored and clients can be billed based on such usage. These methods are often deployed in the field of telecommunications where phone calls and special features such as call waiting are billed as they accumulate. Similar systems have been developed to assist in the billing of computer networks as described in, Reeder, U.S. Pat. No. 5,852,812, entitled, “Billing System For a Network”. Further, available software applications need not be predefined and licensed. Any application so enabled can be executed freely on any system and will simply retroactively bill to a client account located on a computer on a central network.

### SUMMARY OF THE PRESENT INVENTION

Methods and apparatus are disclosed which provide accurate time or usage based metering of client application, or application feature usage, and the reporting of the usage to a site on a public network as an alternative to traditional license granting systems. While the current invention can provide metering and billing facilities to software applications akin to the billing systems deployed by telecommunication companies for line and feature usage, the metering can also emulate traditional licensing models and operate in conjunction with traditional licensing systems.

A presently preferred embodiment of the present invention provides a method and apparatus for performing real-time metering and retroactive billing for software application usage. In another embodiment of the present invention, no billing is involved; rather, information about usage patterns is collected for later analysis. For instance, a Computer Aided Design manager in an electronic design firm can use the present invention to monitor usage of software applications deployed in his department, and identify which software is valuable and which is unused. Similarly, a program manager in a government laboratory, where employees tend to work on several projects funded by several different grants, can use this invention to accumulate usage information on all software applications so that the department providing the services can bill each usage to the correct project. It should thus be clear that the present invention is not only intended to perform software metering as described below with respect to the preferred embodiment, but has a broader use.

### BRIEF DESCRIPTION OF DRAWINGS

FIG. 1 is a diagram schematically illustrating the environment in which the present invention is normally deployed;

FIG. 2 is block diagram generally illustrating how applications are connected in accordance with the present invention;

FIG. 3 is a block diagram generally illustrating the components of the system at the host site;

FIG. 4. is a block diagram generally illustrating the components of the invention at a client site;

FIG. 5 is a block diagram generally illustrating the metering monitor located on a client computer.

FIG. 6 is a flow diagram generally illustrating the execution method of a login tool;

FIG. 7 is a flow diagram generally illustrating the execution method of the client monitoring program;

FIG. 8 is a flow diagram generally illustrating the execution method of a client application;

FIG. 9 is a flow diagram generally illustrating the execution method of the metering monitor located on a client computer;

FIG. 10 is a flow diagram generally illustrating the execution method of the user login request;

FIG. 11 is a flow diagram generally illustrating the execution method of the user logout request;

FIG. 12 is a flow diagram generally illustrating the execution method of the job login request on the metering monitor;

FIG. 13 is a flow diagram generally illustrating the execution method of the job logout request on the metering monitor;

FIG. 14 is a flow diagram generally illustrating the execution method of the feature pool update request on the metering monitor;

FIG. 15 is a flow diagram generally illustrating the execution method of the metering server program;

FIG. 16 is a flow diagram generally illustrating the execution method of the host register on the metering server;

FIG. 17 is a flow diagram generally illustrating the execution method of the user login and logout on the metering server;

FIG. 18 is a flow diagram generally illustrating the execution method of the job login and logout on the metering server; and

FIG. 19 is a flow diagram generally illustrating the execution method of the feature pool update on the metering server.

### DETAILED DESCRIPTION OF A PREFERRED EMBODIMENT

In the following description, various aspects of the present invention will be described. However, it will be apparent to those skilled in the art that the present invention may be practiced with only some or all aspects of the described components. For the purpose of explanation, specific numbers, materials and configurations are set forth to provide a thorough understanding of the present invention. However, it will also be apparent to those skilled in the art that the present invention may be practiced without the specific details. In other instances, well known features are omitted or simplified in order not to obscure the present invention.

Parts of the description will be presented in terms of operations performed by a computer system, using terms such as data, flags, values, characters, strings, numbers and the like, consistent with the manner commonly employed by those skilled in the art to convey the substance of their work to others skilled in the art. As well understood by those skilled in the art, these quantities take the form of electrical, magnetic, or optical signals capable of being stored, transferred, combined, and otherwise manipulated through mechanical and electrical components of the computer system; and the term computer system includes general purpose as well as special purpose data processing machines, systems, and the like, that are standalone, adjunct or embedded.

Various operations will be described as multiple discrete steps in turn, in a manner that is most helpful in understanding the present invention. However, the order of description should not be construed as to imply that these operations are necessarily order dependent. In particular, these operations need not be performed in the order of presentation.

Definition of Fundamental Architectural Components

Credit: An atomic unit of currency in which all transactions are charged.

Credit Pool: A set of credits purchased by a client user.

Host: A computer system.

Feature: An atomic chargeable unit of functionality.

Metering library: A set of functions that relay commands and information between a tool and a metering monitor.

Proprieter: A host, owner, licensor, vendor, reseller, distributor or any other entity having the legal right to permit usage of software applications in or remotely available data in any computer readable form in exchange for the payment of a fee, charge, tariff, tax, credit or any other form of quid pro quo.

Application: A set of features linked to the metering library.

Metering server: A computer program connected to a set of metering monitors via a communications link. The metering server is responsible for collating tool usage information and applying this collated information in the form of credit deductions from client users' credit pool.

Metering monitor: A computer program that receives and batches tool usage information from running tools for secure firewall-transparent communication to a metering server. The metering monitor relays commands and information to running applications. The metering monitor also monitors the state of tools and reports failures and completions to the metering server.

In accordance with the present invention a system is provided whereby a user may execute any number of software applications by downloading or otherwise obtaining a software package from one or a plurality of software proprietors for use on his own client computer. None of the applications need be specifically licensed or protected, and the user is free to use any application enabled in accordance with the present invention irrespective of source. All software usage is automatically controlled and metered on the client system and the metered usage is reported to a metering server located in a host site (or a plurality of sites) where the software usage is accounted for and charged. In the preferred embodiment usage charges are levied against a normalized credit value held with the users account within the database of the metering server. Users can interact with their accounts through a web browser to add extra credit, or to view usage and charge information.

A basic overview of operation of the present invention is as follows:

A user will first create an account with the central billing site 1J and add some credit to his account using well known financial on site or remote transaction facilities and methods.

The user will then load from a data storage medium (such as a magnetic disk or tape, optical disk including CD ROM and DVD, electronic storage media including ROMcard and RAM-card, or any other suitable data storage means), or download from a proprietor's website to his local computer, one or more specially configured software packages. These packages may include, in addition to the client application, an application library having metering means for developing and communicating usage information to an also included metering monitor. An included login tool provides an interactive front end to the metering monitor and enables the user to logon to the remote metering system. The logon process will map the local user on the client computer to an account held in the remote database, and such account will be charged as usage of an application is accumulated. Once logged on, any applications running as a local user will be charged to the remote account. The metering monitor software on the client computer is responsible for accepting usage information from a client application and forwarding that information to the central billing server. Further, the metering monitor is operative to track application exits and to close charging sessions for applications that exit spuriously. In an alternative embodiment of the present invention, the metering monitor may also act as a proxy server, accumulating metering information and forwarding the information as a batch to the central server at periodic intervals set by the server. This is intended to minimize the amount of time the client computer needs to be in contact with its metering server.

Applications are executed. As the applications execute vendor code calls to the client library to indicate that features are in use, the library will forward this information to the metering monitor. The metering monitor will then associate this application with a server account via the map of logged-in users and forward the information to the metering server.

On the metering server, usage reports are compared to a tariff sheet for the user and the account credit value is reduced by an amount as determined by the rate and length of use of a feature. Alternatively, charges could be accumulated and billed to the user.

While the system of the present invention retroactively accumulates and charges for features used, facilities are included to prevent misuse of the system. These facilities include: means for disabling the client applications if usage information does not reach the metering server on a periodic basis, and each communication with the server adds several metrics to help determine if the user is trying to circumvent the system. The metrics may include but are not limited to: transmission times, local times, CPU usage, memory usage and user information.

In FIG. 1 of the drawing, the environment in which the present invention may be deployed is shown. This environment includes a plurality of client computers 1A, some of which may be interconnected by a private network 1C, and may or may not be protected from a public network 1B, as well as other client computers 1A, by a firewall, and a billing site 1J. The billing site 1J is comprised of three main components: (1) a plurality of public hosts 1F that communicate with the client computers via a public gateway 1E and the public network 1B, (2) a plurality of secure hosts 1G, and (3) a database host 1H.

It is well known to those skilled in the art that the environment described in FIG. 1 can also exist at a single location where no public network is involved. It should also be clear that the database host 1H can be distributed across a plurality of sites, or be replicated across a plurality of sites. It is also important to note that the public host (1F) and secure host (1G) roles can be performed by a single component. The public host 1F can even be removed altogether if security is not an issue for a particular utilization of the present invention.

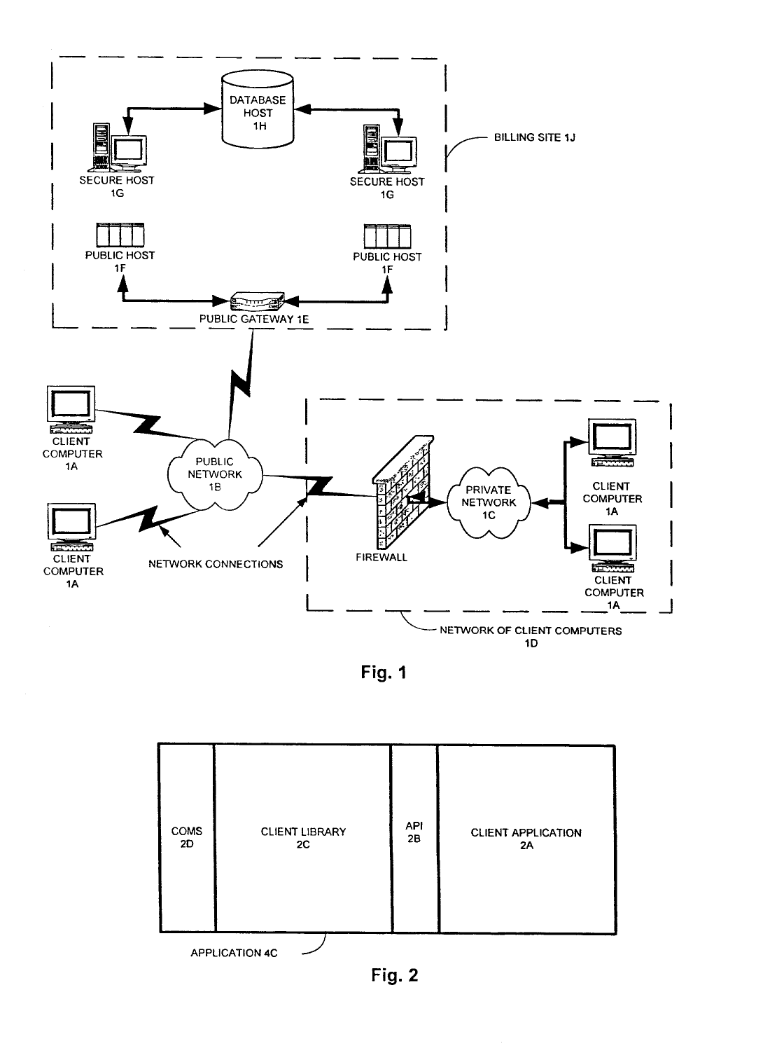

In FIG. 2, an important part of the present invention is illustrated; namely, the architecture of the application package that will be received by a user when he downloads a particular client application 2A. The client library 2C is known to those skilled in the art as a software library that is linked to client application 2A with an Application Programming Interface (API) 2B. The client application 2A has built into it a reporting function that will report to the library 2C all usage of features included or implemented in the client application. The library is responsible for reporting, via an appropriate communication utility COMS 2D, such usage to the metering monitor 4A as is described in more detail below.

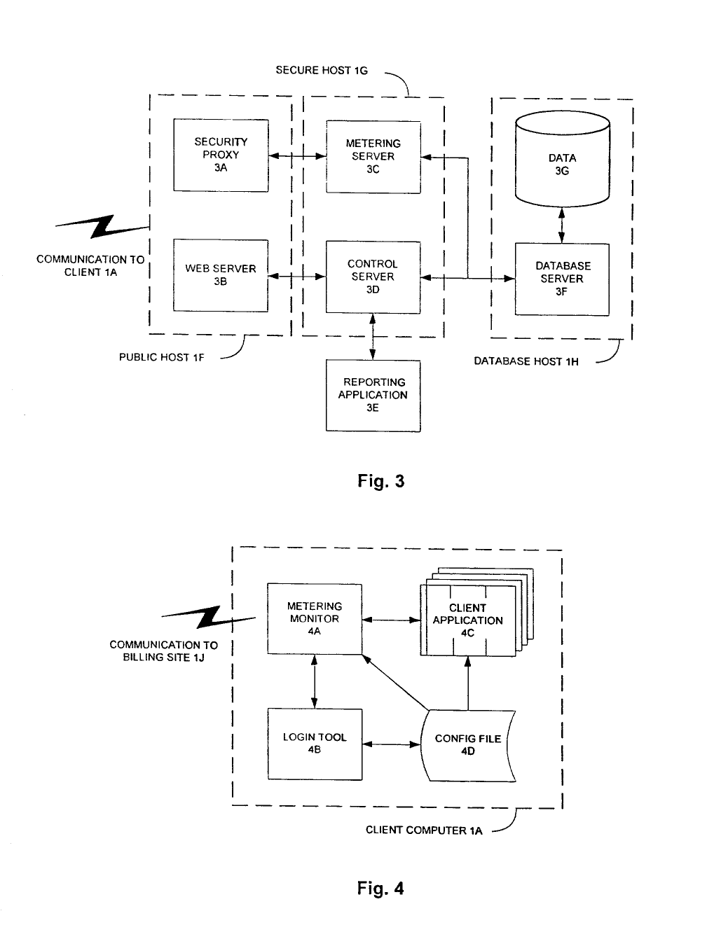

FIG. 3 depicts in more detail certain constituents of one embodiment of a billing site 1J and its three main components as stated above in the description of FIG. 1. The replication of components on the billing site, as illustrated in FIG. 1, is for the purpose of fault tolerance and efficiency. One skilled in the art will no doubt know that all three host components of the billing site may very well be embodied in a single host, or be separated into as many hosts as desired.

Public hosts 1F run a security proxy 3A that filters all communication between client computers 1A and the metering server 3C for security purposes. Public hosts 1F also run web servers 3B to allow end users to access web pages and interact with the billing system through a predefined user-friendly interface. The specification of the interface is out of the scope of this patent application Nevertheless, it should be mentioned for the sake of completeness that this interface allows the end user to pay for the services rendered and to monitor the progress of his running applications as well as a history of jobs he has previously run.

Secure hosts 1G run the metering servers 3C which process requests arriving from client computers 1A through the security proxy 3A and reply to the client computers. The metering servers 3C communicate with the database server host 1H for all persistent information storage and retrieval.

The secure hosts 1G also run a control server 3D that allows users to control and monitor their application progress through the web server 3B (stop application, view statistics, etc.). The control server 3D also allows an independent reporting application 3E to read data stored on the database host 1H. The reporting application will generate accounting reports and statistics reports. It will also permit data entry into the database by authorized personnel.

The database host 1H includes a database server 3F that links the secure hosts 1G to the permanent data storage device DATA 3G. In one embodiment of this invention, the storage device 3G is a large capacity, high speed controlled disk storage unit.

In FIG. 4 one embodiment of that portion of the present invention deployed on a client computer 1A is illustrated in a block diagram comprised of (1) a plurality of client applications 4C (linked with the client library 2C as explained in FIG. 2) that the user wishes to run on the client computer 1A; (2) a login tool 4B that will initiate the communication with the billing site 1J and identify the user to the billing site; (3) a metering monitor 4A that monitors the client applications 4C on this client computer; (4) a configuration file 4D which is a medium that stores current configuration parameters that enable correct behavior of the entire system on this client computer.

In this embodiment, only one metering monitor 4A exists per client computer 1A. In another embodiment, one metering monitor per user (as defined by the operating system running on the client computer) can be used.

It is unimportant to the present invention how a configuration file is obtained. In one embodiment, a default configuration file is supplied with each client application. In another embodiment, the login tool is able to read, but also modify according to user input and store a configuration file.

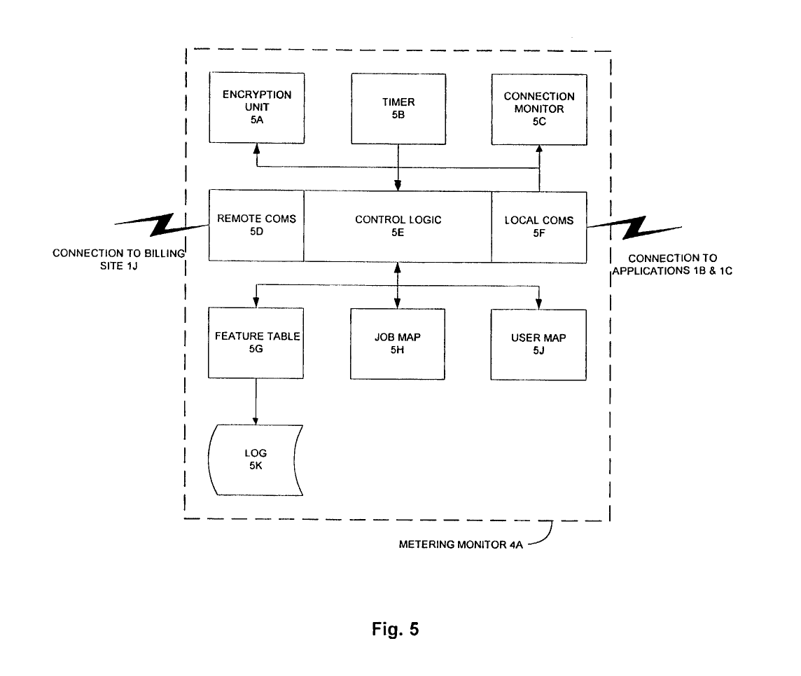

In FIG. 5, a block diagram is shown of one embodiment of a metering monitor 4A that can monitor a plurality of client applications 4C that may be started by many different users on the same the client computer 1A. The metering monitor stores a User map 5J that identifies to the billing site every user currently running an application on this computer. It also stores a job map 5H that maps the local identity of a running client application 4C to a unique number allocated by the database 3G and to which user the running application belongs. The metering monitor communicates with the client applications via the local coms 5F and with the billing site 1J (through the security proxy 3A) via the remote COMS 5D. In one embodiment of the metering monitor, all communications are encrypted before transmittal, and are decrypted upon reception by the encryption unit 5A. The encryption method is unimportant to the present invention. To minimize the number of communications with the billing site, the metering monitor also keeps track in a pending feature table 5G of all pending features being used by the client applications on the client computer. The pending feature table 1G may also be stored on a persistent storage device (such as a hard disk) for recovery after failure. Since some client applications 4C may die unexpectedly without reporting their status, a timer 5B causes the metering monitor to perform periodic checks via its connection monitor 5C to make sure that all client applications are still running. If it detects that one application has terminated unexpectedly, the metering monitor performs operations to inform the billing site.

In another embodiment of the present invention, a subset or the entire functionality of the metering monitor is embedded in the client library 2C. Therefore, a client application 4C is able to communicate directly with the billing site 1J and thus transmit metering information directly thereto. However, the metering monitor functionality is embedded, it can no longer detect spurious termination of client applications.

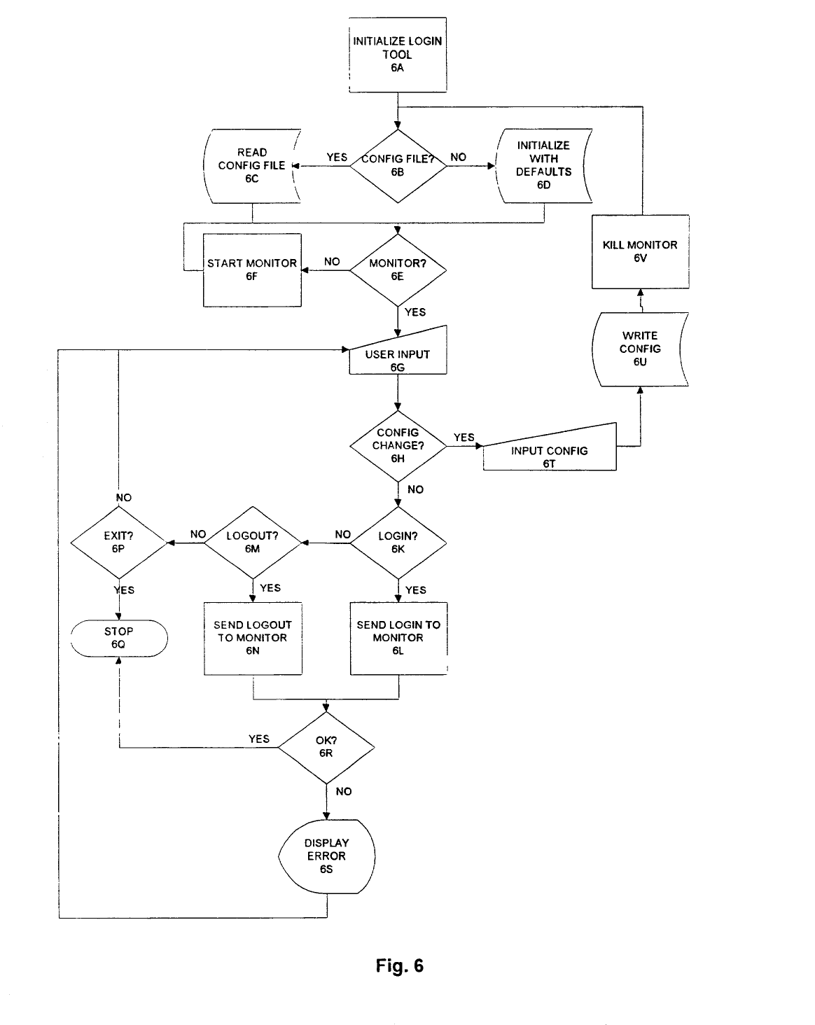

FIG. 6 is a flow chart illustrating operation of one embodiment of the login tool 4B. On start-up, the user initializes and runs the login tool before starting any client application (4C), either to update the configuration file 4D or to identify himself to the billing site 1J.

After starting (initialization at 6A), the login tool 4B first reads in the configuration parameters (6C) from the configuration file 4D if the file exists, otherwise it uses default parameters as per 6D. As indicated at 6G, the login tool can also be used to modify the parameters in the configuration file to match the user's specific environment and preferences. Modified parameters will be stored in the configuration file. After this initialization phase, the login tool checks to see if a metering monitor 4A is running on the client computer 1A. If not, then it starts one in step 6F. The login tool 4B is an application that waits for user input after it is started. At this point, the user can decide to execute one out of four actions (1) change the configuration (6H): in this case, the new configuration is saved in the configuration file in step 6U and the running metering monitor is terminated in step 6V (which is necessary to ensure that the new metering monitor as started at 6F reads in the correct updated configuration information). (2) login (6K): the user is prompted for a username and a password which are sent to the metering monitor in step 6L. After this login, the user can start running applications on his client computer. (3) logout (6M): the user is prompted for a user name and a password, which are relayed to the metering monitor in step 6N. After the user logs out successfully, he cannot start any new applications on this client computer until he logs in again. (4) Exit (6P): the login tool quits in step 6Q. If either a login or a logout does not succeed (because of nonexistant user name, wrong password, etc.), an error message is displayed in step 6S. It should also be noted that the metering monitor retains the state of the users logged in, thus the login tool can be exited safely without affecting any currently running applications or applications about to start running.

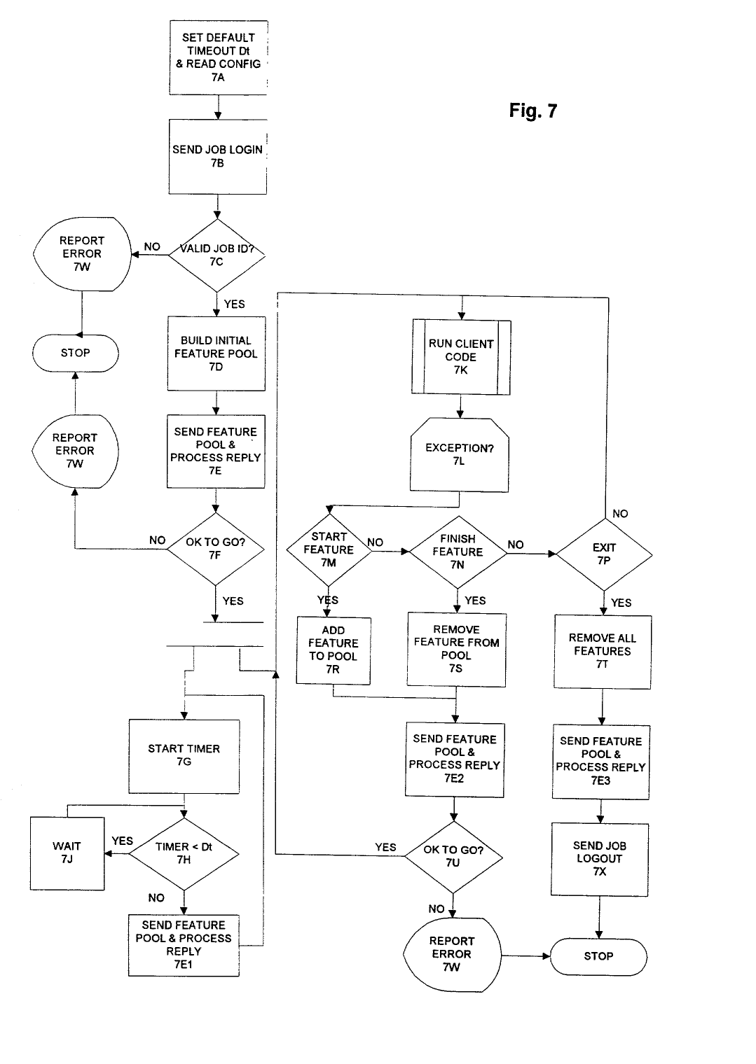

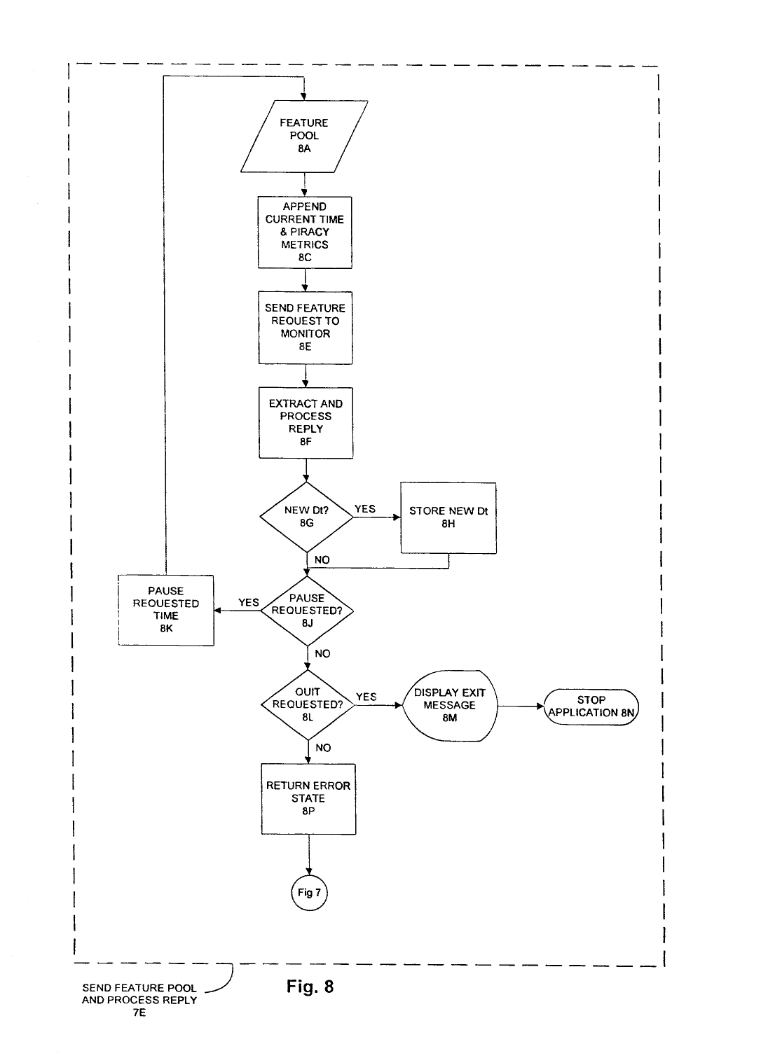

FIG. 7 is a flow chart illustrating interaction between a client application 4C and the present invention. The client application starts at 7A by reading in the configuration file 4D and setting an alarm to some predefined time period Dt. In step 7B, the client application sends a job register (login) message to the metering monitor 4A running on the same client computer 1A as the client application. If the client application does not receive back a valid job identification from the metering monitor, it reports an error message in step 7W then quits. Otherwise, in step 7D, the client application builds a pool of features it would like to use in light of the task it is asked by the user to perform. In step 7E, the client application sends the pool of features to the metering monitor 4A and processes the reply, as described in more detail in FIG. 8. If the metering monitor answers that the client application is not authorized to run, the client application reports the error in step 7W and quits. Otherwise, the client application starts a timer in step 7G and goes on to run the client code part of client application 2A (FIG. 2) in step 7K. As soon as the set timer reaches Dt, the client application 4C sends the current feature pool to the metering monitor and processes its reply in step 7E before starting the timer again for the next period of time Dt. While the client application is running, it will raise an exception (at 7L) whenever there is a feature change request. If the client application requests a feature start, it will add the feature to the feature pool in step 7R. If the client application is finished with a particular feature, it will remove the feature from its feature pool in step 7S. In both cases, the client application sends the feature pool to the metering monitor and processes its reply (at 7E2). If the reply does not authorize the application to continue, the application will report the error in step 7W and quit. The client application can also issue a request to terminate, in which case, it will remove all features from its feature list in step 7T, send the empty feature pool to the metering monitor, process its reply (step 7E3), send ajob logout in step 7X, and then stop.

FIG. 8 illustrates in more detail the process of step 7E “send feature pool and process reply”. In step 8C, the client application 4C appends the current time (as a timestamp) and piracy-deterrent metrics to its current feature pool. The form of the piracy-deterrent metrics is unimportant to the present invention, and it should be clear to those skilled in the art that one could use any form of piracy-deterrent metrics or none at all. The application then sends the feature request to the metering monitor (8E) and waits for the reply. In step 8F, the application extracts the relevant reply information from the metering monitor. The monitor may include in the reply a parameter Dt which informs the client application about the length of the next period of time it is allowed to run without contacting the monitor. If this parameter is included in the reply, in step 8H the client application will store the parameter Dt in a memory location where it is checked in step 7H (of FIG. 7). The metering monitor may request that the application freeze for a certain period of time, in which case, the client application will pause for the requested time in step 8K. The metering monitor may alternatively request at 8L that the client application quit, in which case, the client application will display an exit message in step 8M and quit. If no pause or quit is requested by the metering monitor, the client application will store a reply status in a memory location for other parts of the client application to consult.

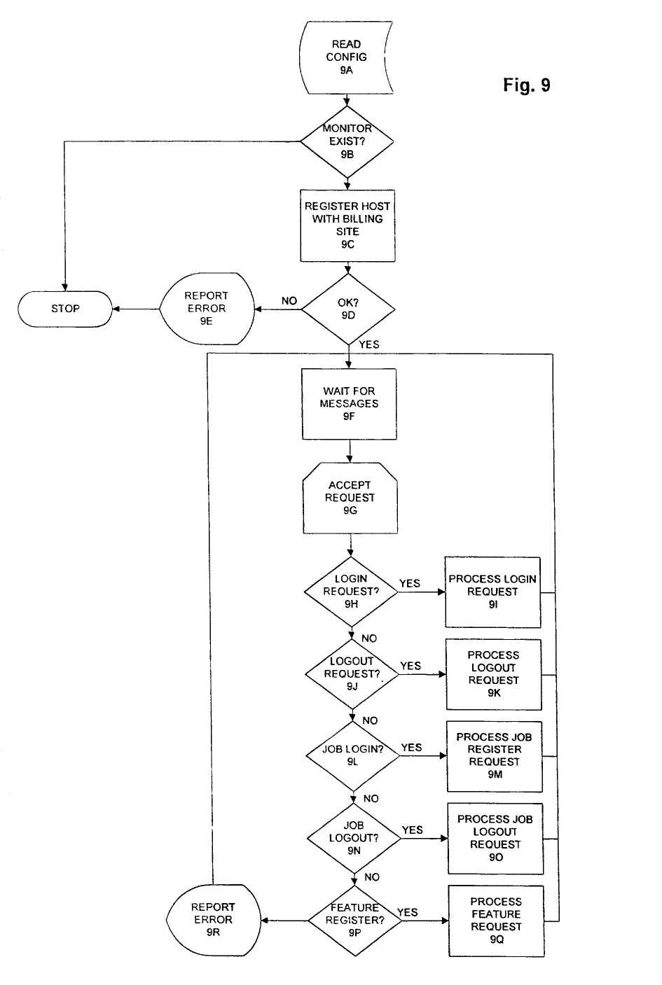

FIG. 9 presents an overall depiction of the metering monitor's function. When a metering monitor 4A starts on a client computer 1A, it reads the configuration file 4D to obtain the system parameters. It then checks at 9B for the existence of another metering monitor running on the same the client computer using the same the configuration file. If such a metering monitor exists, the newly started monitor quits. If not, in step 9C, the metering monitor registers its identity as well as the identity of the client computer it is running on with the billing site's metering server 3C. The metering server returns a status code to the metering monitor signifying that the metering monitor is authorized to continue running or is not authorized to run. This allows the implementation of security protocols and software export restrictions for example. Once it clears step 9D, the metering monitor starts accepting messages (9F) from client applications through a communications channel defined in the configuration file 4D. In the preferred embodiment of the present invention, only client applications running on the local client computer send messages to the metering monitor. Other client applications running on a different client computer will send their messages to another metering monitor that is running on the same client computer as they are.

At step 9G, the metering monitor receives a message from a client application running on the local client computer and decrypts its content if applicable. The request could be one of five request types:

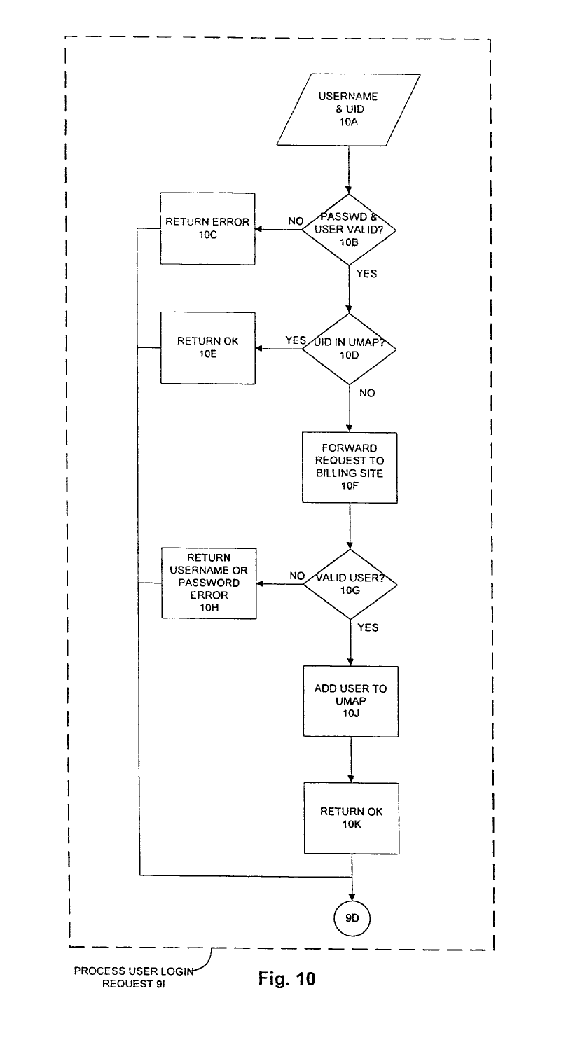

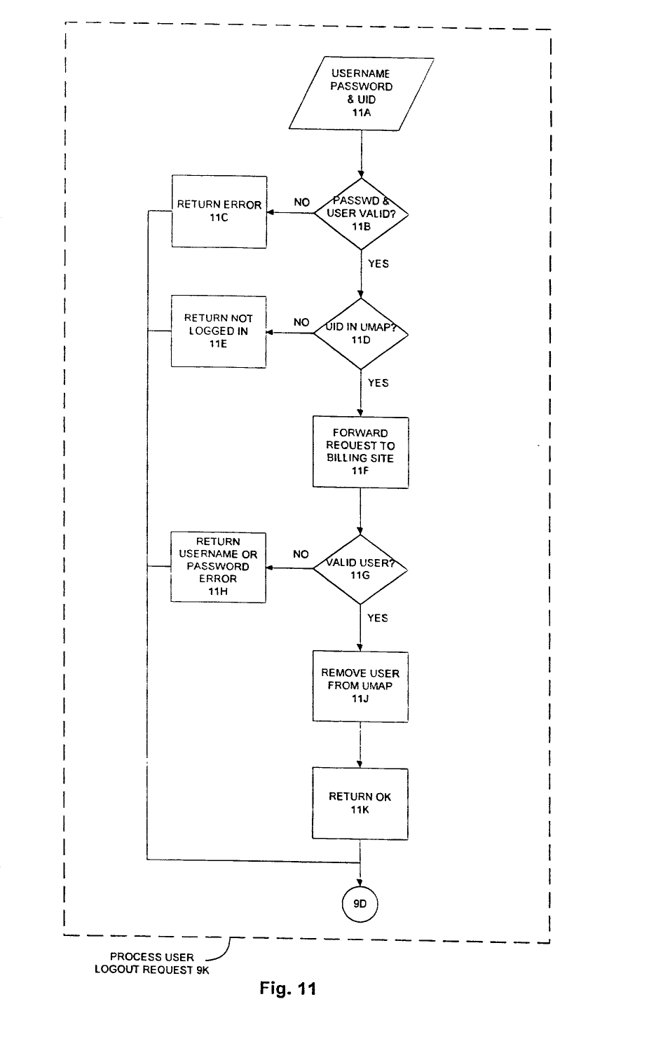

(1) User login request: in step 9I, the metering monitor processes the user login request it received from a login tool 4B. This process is described in more detail in FIG. 10.

(2) User logout request: in step 9K, the metering monitor processes the user logout request it received from a login tool 4B. This process is described in more detail in FIG. 11.

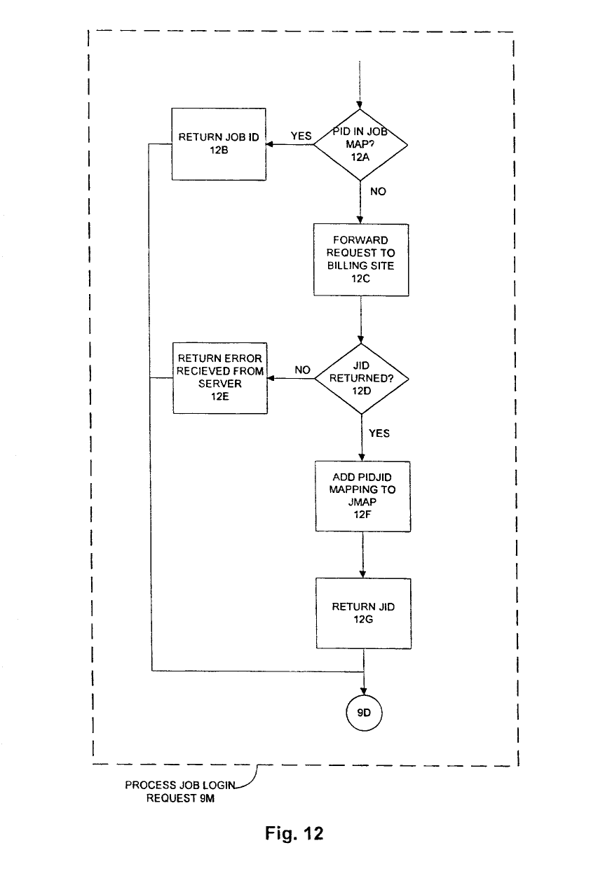

(3) Job login request: in step 9M, the metering monitor processes the job login request it received from a client application 4C which is starting. This process is described in more detail in FIG. 12.

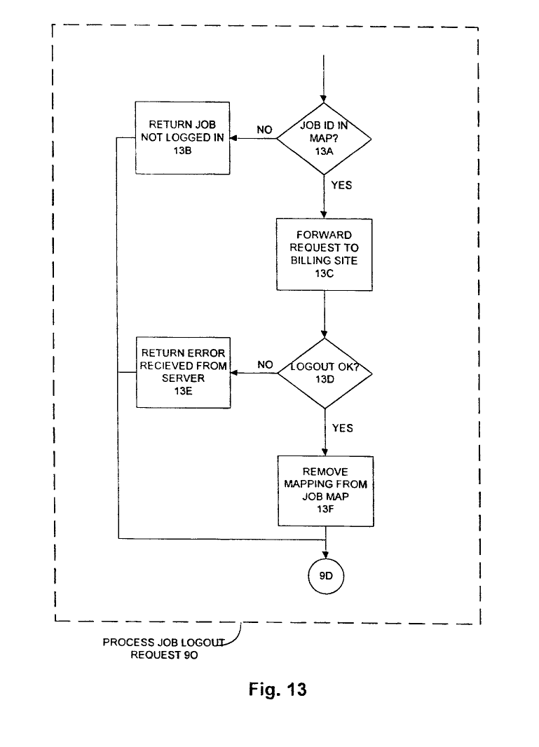

(4) Job logout request: in step 9O, the metering monitor processes the job logout request it received from a client application 4C which is finishing. This process is described in more detail in FIG. 13.

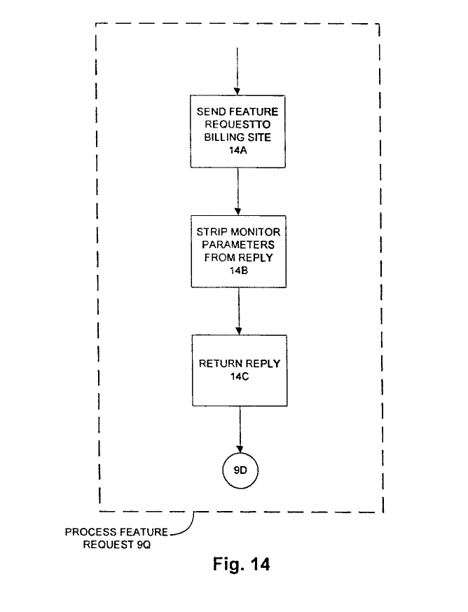

(5) Feature register request: in step 9Q, the metering monitor processes a feature pool request it received from a client application 4C at one of the steps 7E. This process is described in more detail in FIG. 14.

After processing the received request, the metering monitor waits (9F) for the next message to arrive.

The metering monitor 4A may communicate with several client applications at the same time. For efficiency reasons, one embodiment of the metering monitor processes several requests at the same time. The way the metering monitor manages to process multiple requests at the same time is unimportant to the present invention, and those skilled in the art know that there are many technologies available for this purpose. Among these technologies are multithreading and multiprocessing.

FIG. 10 is a flow diagram illustrating one embodiment of a user login request (see 9I in FIG. 9) as processed by a metering monitor 4A. To login, a user uses the login tool 4B to specify his unique user name as known by the billing site and the password associated with that user name. The metering monitor 4A running on the local client computer 1A maintains a table of user names and their corresponding user identification UID as known to the client computer's operating system. In step 10B, the metering monitor makes sure the user name and password supplied are valid in the sense that they only use authorized characters. In step 10D, the metering monitor checks to see if the user name is already logged into the metering monitor's table of user names. If it is so, the metering monitor returns OK in step 10E. Otherwise, in step 10F, the metering monitor forwards the login request to the metering server 3C on the billing site 1J and waits for its answer. If the metering server returns that the user name is valid and that the password matches the user name, the metering monitor adds the user name to its table of logged in users and returns OK. Otherwise, the metering monitor returns the proper error code.

FIG. 11 is a flow diagram depicting one embodiment of a user logout request as processed (see 9K in FIG. 9) by metering monitor 4A. To logout, a user uses the login tool 4B to specify his unique user name as known by the billing site and the password associated with that user name. In step 11B, the metering monitor makes sure the user name and password supplied are valid in the sense that they only use authorized characters. In step 11D, the metering monitor checks to see if the user name is already logged into the metering monitor's table of user names. If the user name is not logged in, the metering monitor returns the proper error code in step 11E. Otherwise, the metering monitor forwards the login request to the metering server 3C on the billing site 1J and waits for its answer. If the metering server returns that the user name and password do not match, the logout request is denied and the metering monitor returns the proper error code in step 11H. Otherwise, the metering monitor removes the user name from its table of logged in user names and returns OK.

FIG. 12 is a flow chart depicting one embodiment of a job login request (see 9M in FIG. 9) as processed by a metering monitor 4A. When a client application 4C starts, it sends a job login request in step 7B (FIG. 7). The metering monitor running on the same client computer receives the job login request that includes the application process identification PID as known to the operating system of the client computer. The metering monitor checks in step 12A whether the PID is logged into the metering monitor's table of logged in jobs. If the job is logged in, the metering monitor returns a job identification corresponding to the PID that is stored in its table of logged in jobs. Otherwise, as indicated at 12C, the metering monitor forwards the job login request to the billing site's metering server (FIG. 3) 3C and waits for the response. If the response does not contain a valid job identification as defined by the design of both the metering monitor and the metering server, the metering monitor returns to the client application the proper error code in step 12E. Otherwise, the metering monitor adds the received job identification along with the PID to the metering monitor's table of logged in jobs (JMAP), creates an empty feature pool for the job and returns the job identification (JID) to the client application.

In another embodiment of the metering monitor, the client application may specify an initial pool of features it would like to use at the same time it is requesting ajob login. The metering monitor will then process the feature pool request at the same time as the job login request; this saves time and does not overload the billing site's metering server with too many requests.

FIG. 13 is a flow diagram depicting one embodiment of a job logout request (see 90 in FIG. 9) as processed by the metering monitor 4A. When a client application finishes, it sends a job logout request (see step 7X of FIG. 7) to the metering monitor. The metering monitor in step 13A first checks to see that the job is logged in and has a proper job identification. If the job is logged in, as indicated at 1 3C, the metering monitor forwards the job logout request to the billing site's metering server and waits for a response. If a proper response is received as indicated at 13F, the metering server removes the job from the metering monitor's table of logged in jobs and returns OK. Otherwise, the metering monitor returns a proper error code at 13E to the client application.

FIG. 14 is a simplified flow diagram depicting the process by which a metering monitor processes a feature pool request (see 9Q in FIG. 9). When the metering monitor 4A (FIG. 4) receives a feature pool request from a client application 4C, the metering monitor forwards the request to the billing site's metering server and waits for a response. When the response is received, the response is stripped from metering monitor's own parameters, and the rest of the response is returned to the client application.

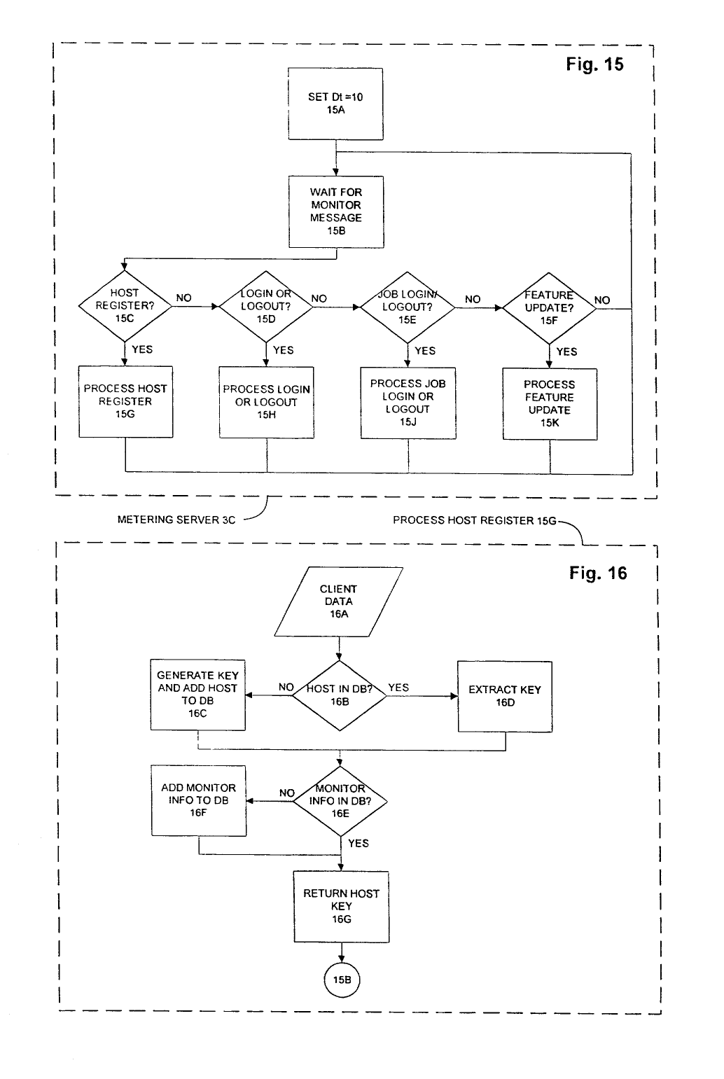

FIG. 15 is a flow diagram depicting one embodiment of the metering server 3C (see FIG. 3) that exists at the billing site 1J (FIG. 1). To support redundancy there could be a plurality of metering servers available at the billing site 1J. Any of the metering servers can serve any incoming request from a remote metering monitor.

When a metering server starts, it waits (in step 15B) for a client request to arrive. As soon as a request arrives, it is decrypted and its content examined to find out the type of request it is. The request could be one of four basic types:

(1) host register request: in step 15G, 15G, the metering server processes the host register request;

(2) user login or logout: in step 15H, the metering server processes the user login or logout request;

(3) job login or logout request: in step 15J, the metering server processes the job login request;

(4) feature pool update request: in step 15K, the metering server processes the feature pool update request.

After servicing the request, the metering server waits for the next request to serve in step 15B.

FIG. 16 is a flow diagram depicting processing of the host login request by metering server 3C (FIG. 3) as invoked in step 15G. The metering server receives from a metering monitor 4A (FIG. 4) running on a client computer 1A, information that identifies uniquely the client computer 1A as well as some information about the metering monitor itself. In step 16B, the metering server checks to see whether the client computer is logged into the database host 1H (FIG. 1). If the client computer is not logged into the database host, the metering server logs the client computer into the database host in step 16C. Then, the metering monitor checks to see whether the metering monitor is logged into the database host 1H. If the metering monitor is not logged into the database host, the metering server logs the metering monitor into the database host in step 16F. Then, the metering server returns OK and a host ID to the metering monitor.

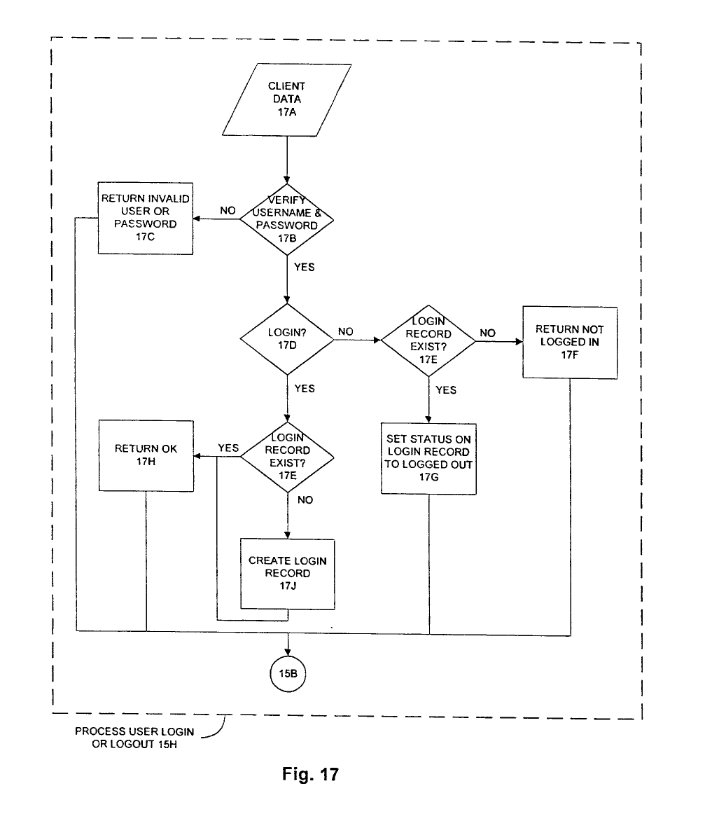

FIG. 17 is a flow diagram depicting “user login or logout” processing by a metering server 3C (FIG. 3) as invoked in step 15H (FIG. 15). The metering server 3C receives from the metering monitor running on the client computer 1A the request type and a user name and a password and the client computer identification. As indicated at 17B, the metering server checks with the database host 1H to ensure that the user name is valid and that the password matches the corresponding password to the user name. If this is not the case, the metering server will return the proper error code to the metering monitor (invalid user name or password) in step 17C. Otherwise, the metering server checks for the request type:

(1) if it is a login request: the metering server at 17E checks with the database host to see whether a login record exists for the user name on the client computer. If it does, the metering server will return OK to the metering monitor. If it does not, the metering server will request the database host to create a login record for the user name in step 17J, set its status to “logged in” and then in step 17H, return OK.

(2) if it is a logout request: the metering server checks with the database host to see whether a login record exists for the user name on the client computer. If it does, the metering server will request the database host to set the status of the record to “logged out” in step 17G and then in step 17H return OK. If it does not exist, the metering server will return the proper error code (user name not logged in) to the metering monitor.

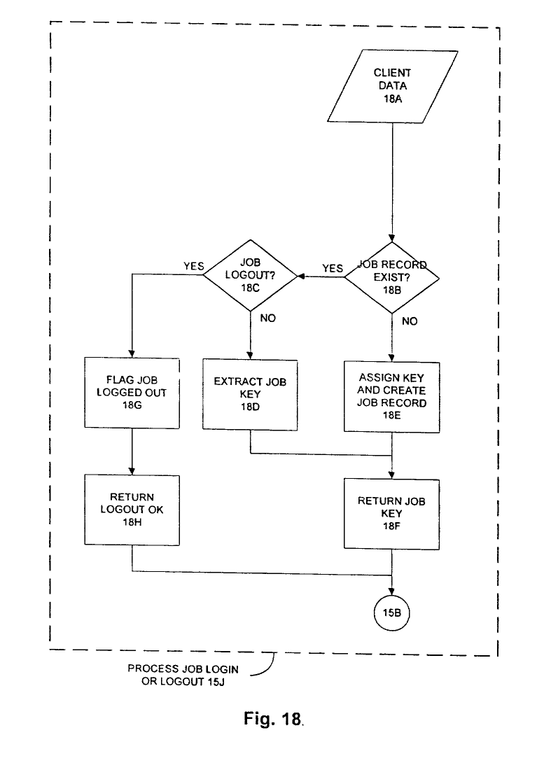

FIG. 18 is a flow diagram depicting ajob login processing by a metering server 3C (FIG. 3) as invoked in step 15J. The metering server 3C receives data from a metering monitor 4A (FIG. 4) running on a client computer 1A (FIG. 1) to request that a newly started job be logged in on the client computer. In step 18B, the metering server checks with the database host 1H (FIG. 1) for the existence of a record pertaining to the job. If such a record exists, the metering monitor extracts from the record the job key in step 18D. Otherwise, the metering server assigns, in step 1 8E, a unique job key to the job and requests that the database host create a new record for the job in the database. In step 18F, the metering server returns the job's key to the metering monitor.

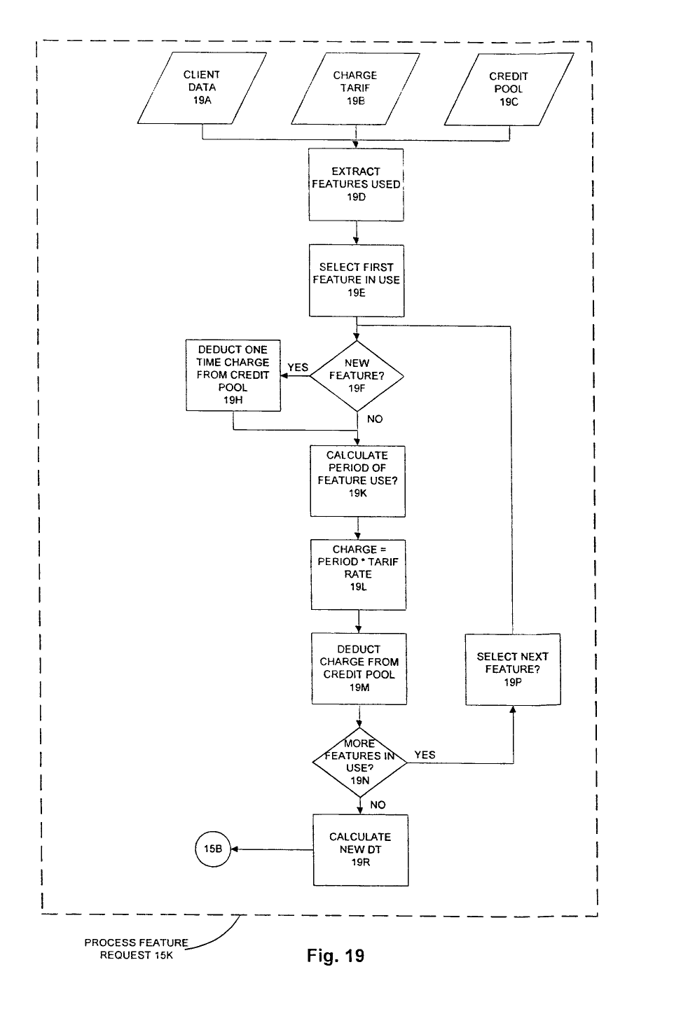

FIG. 19 is a flow diagram illustrating steps involved in the execution of a feature pool update as processed by a metering server 3C (FIG. 3). As indicated at 19A, a metering server receives as part of the feature pool update request (15K in FIG. 15), the client's data (user name and ajob key). The metering server can also lookup on the database host 1H the charging tariff 19B for any feature and the credit pool balance 19C of the user. In step 19D, the metering server extracts from the request message the list of features used by the job and time of use. What follows is applied to each one of the used features. The metering server picks one feature from the used features and checks in step 19F to see if the feature has already been reported as being used by the job in a previous request. If not, the metering server checks to see if the feature's charging tariff requires that usage of such feature must be charged an initial usage fee, in which case the amount is deducted from the user's credit pool in step 19H. If the feature has only a “per use” charge, the metering server moves on to the next feature to process in the feature pool at hand. Otherwise, in step 19K, the metering server calculates the exact period of time during which the feature was in use by the job (the current time minus the time of the last feature pool update). In step 19L, the metering server calculates the actual charge from the usage period and the specific feature tariff. In step 19M, the charge is deducted from the user's credit pool. Then, the metering server moves on to process the next feature in the feature pool until all are processed.

In another embodiment of the metering server, the metering monitor also includes use of the feature pool by a job during an upcoming period of time during which the job is authorized to continue running. The feature pool is used by the metering server to evaluate, depending on the amount of credit left in the user's credit pool, whether the job should be allowed to continue for the standard period of time or whether the allowed period of time should be restricted to a smaller period. Typically, this would be the case when the user does not have enough credit in his credit pool to enable use of all the requested features for the standard period duration without creating a negative balance in his credit pool.

Although the present invention has been described above in terms of specific embodiments, it is anticipated that alterations and modifications thereof will no doubt become apparent to those skilled in the art. It is therefore intended that the following claims be interpreted as covering all such alterations and modification as fall within the true spirit and scope of the invention.

What is claimed is:

1. A method of enabling fee based access to one or more software applications, comprising:
establishing a user account with a billing site which responds to input user information and correspondingly debits the user account;
obtaining an application package for use on a client computer, the application package including a metering monitor, a login tool, one or more client applications, and an application library having metering means for developing information relating to usage of said client applications;
using said login tool to establish communication with said user account at said billing site;
using said metering means to obtain and communicate to said metering monitor usage information relating to usage of said client applications on said client computer;
using said metering monitor to communicate said usage information to said user account at said billing site; and
using the usage information to debit said user account.

2. A method as recited in claim 1 wherein said user obtains said application package from a software proprietor.

3. A method as recited in claim 2 wherein said application package is contained on a data storage medium included in the group consisting of magnetic storage tapes, magnetic storage disks, optical data storage disks, optical data storage disks, and electronic data storage cards.

4. A method as recited in claim 2 wherein said user obtains said application package by downloading it from a software proprietor's website.

5. A method as recited in claim 1 wherein said application package further includes a configuration file, and wherein on startup of a client application, said login tool is used to update said configuration file and identify the user to the billing site.

6. A method as recited in claim 1 wherein on login said billing site communicates or withholds authorization to run said client application based upon the state of the user's account.

7. A system for providing fee based access to one or more software applications and for remotely monitoring use thereof, comprising:
means forming a billing site having
a database for storing user account information,
communication means for receiving application usage data, and
processing means for processing the usage data, attributing a cost to said usage
data, and debiting said cost to a corresponding user account in said database;
a client computer communicatively associated with said billing site; and
an application package installed on said client computer, said application package including a metering monitor, a login tool, one or more client applications, and an application library having metering means for developing information relating to usage of said client applications;
wherein said login tool is used to establish communication with a user account at said billing site, said metering means is used to obtain and communicate usage information relating to usage of said client applications to said metering monitor, and said metering monitor is used to communicate said usage information to said user account.

8. A system as recited in claim 7 wherein said application package further includes a configuration file, and wherein on startup of a client application, said login tool is used to update said configuration file and identify the user to the billing site.

9. A system as recited in claim 8 wherein said metering monitor is used to identify the software application in use by said client computer.

10. A system as recited in claim 7 wherein said metering monitor generates and communicates to the billing site a user map that identifying every user currently running a client application on said client computer.

11. A system as recited in claim 10 wherein said metering monitor also generates a job map that maps the local identity of a running client application to a single number allocated by said billing site and to the user to which the running client application belongs.

12. A system as recited in claim 7 wherein all user information communicated between said metering monitor and said billing site is encrypted.

13. A system as recited in claim 7 wherein said metering monitor keeps track in a pending feature table, all features being used by said client applications.

14. A system as recited in claim 13 wherein said pending feature table is stored on a persistent storage means for recovery in the event of a system failure.

15. A system as recited in claim 7 wherein a timing means is used to cause said metering monitor to perform periodic connection checks to determine whether or not any running client applications have unexpectedly terminated without reporting their status.

16. An application package for installation on a client computer, comprising:
a metering monitor,
a login tool,
one or more client applications, and
an application library having metering means for developing information relating to usage of said client applications;
wherein said login tool is used to establish communication with a user account at a billing site, said metering means is used to obtain and communicate to said metering monitor usage information relating to usage of said client applications, and said metering monitor is used to communicate said usage information to said user account at said billing site.

17. A system as recited in claim 16 wherein said metering monitor is also used to identify the software application in use by said client computer.

18. An application package as recited in claim 16 further comprising a configuration file for storing configuration parameters that enable correct operation of a system using the application package.

19. An application package as recited in claim 18 wherein on login said metering monitor grants or withholds authorization to run said client application based upon the state of the user's account.

20. An application package for installation on a client computer, comprising:
a login tool,
one or more client applications, and
an application library having metering means for developing information relating to usage of said client applications and a metering monitor;
wherein said login tool is used to establish communication with a user account at a billing site, said metering means is used to obtain and communicate to said metering monitor usage information relating to usage of said client applications, and said metering monitor is used to communicate said usage information to said user account at said billing site.
